(19) United States
(12) Patent Application Publication
(10) Pub. No.: US 2014/0235111 A1
(43) Pub. Date: Aug. 21, 2014

(54) CABLE RODS

(71) Applicant: Super Rod Limited, Torfaen (GB)

(72) Inventor: Malcolm Duncan, Nr Abergavenny (GB)

(21) Appl. No.: 14/185,367

(22) Filed: Feb. 20, 2014

(30) Foreign Application Priority Data
Feb. 20, 2013 (GB) 1302956.6

(51) Int. Cl. H01R 4/56; H01R 43/04

(52) U.S. Cl. CPC H01R 4/56; H01R 43/04
USPC 439/801; 29/882

(57) ABSTRACT

A flexible cable rod (7) and method of making same is disclosed the rod having male and female connectors (1, 4) fixed to each end for connection to another such cable rod or a cable rod tool, the connectors include threaded bores into which the free ends of the cable rod are inserted during manufacture to be thereafter swaged or crimped over the end of the cable rod such that the threads in the bores (6, 8) acting as teeth to grip the outer edges of the cable rod in this region.

### CROSS-REFERENCE TO RELATED APPLICATIONS

This application claims priority to United Kingdom Patent Application No. GB1302956.6, filed Feb. 20, 2013, which application is incorporated herein by reference in its entirety.

### FIELD OF THE INVENTION

This invention relates to cable rods of the type which include e.g. threaded connectors at each end by which multiple rods may be joined together and can be used for installing or removing cabling such as electric wiring or optical fibers.

### BACKGROUND OF THE INVENTION

Cable rods of the foregoing type necessarily have to be flexible but stiff along their major axes, as well as having great tensile strength for pulling loads when installing cabling, such as those cable rods available from Super Rod Ltd. located at Unit 12, Gilchrist Thomas Industrial Estate, Blaenavon, Gwent, Wales, NP4 9RL, United Kingdom which advertise a pulling strength of 200 kg. These requirements limit the choice of material suitable for cable rods to high grade plastics such as nylon and resin impregnated fiberglass where more flexibility and more rigidity is required and in a similar manner there is a limited choice as to how the cable rod connectors can be attached to the end of the cable rod without damaging the rod. They can, for example, be secured by a suitable epoxy resin, but this is time consuming and complicated with inconsistent results and special handling being required to conform to health and safety regulations. A favored alternative is to instead use complementary pairs of threaded male and female cylindrical brass connectors having smooth connection bores of diameter slightly greater than the cable rod, with each connector thereafter being pinched or swaged over a respective end of the connector rod to reduce the diameter of the connector and bore so that the connectors press tightly around the ends of the cable rod. Whilst this solution is relatively straightforward care must be taken, particularly in the case of glass fiber cable rods, to ensure that the fibers are not crushed and hence the rod weakened in this section. In the case of high grade plastics cable rods such as those made of nylon this is less of a problem but care still needs to be taken to ensure that the nylon is not compressed too much to the extent that it is partially extruded out of the bore in the connector during the swaging process. Hence, particularly in the case of cable rods made from e.g. nylon, there is a practical upper limit to the pull-out/pull-up value attainable through the use of the swaging process and hence there is a practical limit to the amount such a cable rod can lift before the connector and the rod itself separate under load.

Thus, there is a long-felt need for a cable rod which includes threaded connectors at each end such that multiple rods may be joined together and can be used for installing or removing cabling such as electric wiring or optical fibers.

### BRIEF SUMMARY OF THE INVENTION

The present invention is derived from the realization that a different approach which does not purely rely upon a squeezed or swaged connection between the end of the cable rod and the metal, typically brass, connector would be desirable if it can improve the tensile strength between the connector and the cable rod.

According to the invention there is provided a flexible cable rod having male and female connectors fixed to each end for connection to another such cable rod or a cable rod tool, the connectors including threaded bores into which the free ends of the cable rod has been inserted during manufacture to be thereafter swaged or crimped over the end of the cable rod, with the threads in the bores acting as teeth to grip the outer edges of the cable rod in this region.

With this arrangement a considerable improvement can be achieved by the elegantly simple expedient of, when forming bores and threads on the cable rod connectors by forming an additional thread in the otherwise smooth connector bore and using that thread for a different purpose i.e. to grip the outside of the end of the rod after it has been swaged or crimped onto it.

These and other objects, features and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a perspective view of a male brass connector of the invention; and,

FIG. 2 is a perspective view of a female brass connector swaged onto the end of a cable rod.

### DETAILED DESCRIPTION OF THE INVENTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this patent is not limited to the particular methodology, materials and modifications described and as such may, of course, vary. It is also understood that the terminology used herein is for the purpose of describing particular aspects only, and is not intended to limit the scope of the present invention as claimed.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

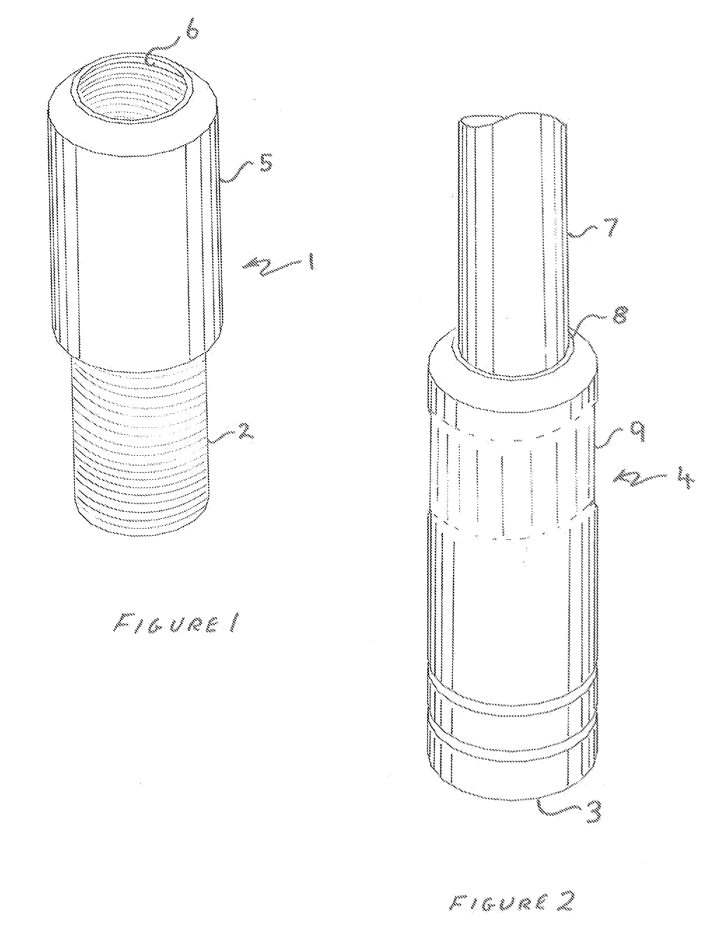

FIG. 1 shows a generally cylindrical brass male connector 1 having a threaded, male connector end 2 for fitting into the threaded female end 3 of a female connector 4 as shown in FIG. 2. The male connector 1 has a collar portion 5 which includes a threaded, blind, bore 6 for receiving, in use, an end of a cable rod 7 as shown in FIG. 2. The female connector 4 has a correspondingly blind, threaded bore 8 by which it can receive the end of the cable rod 7; the radially recessed region 9 shows that it has been swaged i.e. pressed or crimped against the outer walls of the rod 7 in this region to form a permanent fixing in which the threads within the female connector 4 bite into the end of the rod 7 to increase the grip of the connector 4 on the rod 7.

In a similar manner, the male connector 1 can be swaged about its cylindrical part 5 after it has been fitted to the other end of the cable rod 7 to therefore provide a complete cable rod with increased tensile strength. In tests it has been shown that, as compared to a conventional cable rod of the type referred to earlier, which have an average failure under a 218 kg load, corresponding tests on cable rods with connectors made in accordance with the invention failed on average under a load of 330 kg, representing a 66% increase in tensile strength before failure.

The invention therefore provides a simple solution to the problem of ensuring that the ends of the cable rod are not damaged during the pinching or swaging process as a result of too much mechanical pressure being applied to the connectors 1, 4 by using the threaded portion of the connectors as teeth in the swaged region to thereby substantially increase the strength of the connection.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A flexible cable rod (7) having free ends and male and female connectors (1, 4) fixed to each end for connection to another such cable rod or a cable rod tool, the connectors comprising:
threaded bores inserted into the free ends of the cable rod (7) during manufacture and thereafter swaged or crimped over the ends of the cable rod, with threads in the bores acting as teeth to grip outer edges of the cable rod in this region.

2. The flexible cable rod recited in claim 1, wherein the connectors (1, 4) are generally cylindrical.

3. The flexible cable rod recited in claim 1, wherein the connectors (1, 4) are formed of brass.

4. The flexible cable rod recited in claim 1, wherein the male connector (1) has a threaded male connector end for fitting into a threaded female end of a female connector of a further rod or rod tool.

5. The flexible cable rod recited in claim 1, wherein the female connector (4) has a threaded, female connector end for fitting into a threaded male end of a male connector of a further rod or rod tool.

6. The flexible cable rod recited in claim 1, wherein the male connector (1) has a collar portion (5), which includes a blind, threaded bore for receiving an end of a cable rod.

7. The flexible cable rod recited in claim 1, wherein the female connector (4) has a collar portion (9), which includes a blind, threaded bore (8) for receiving an end of the cable rod (7).

8. The flexible cable rod recited in claim 1, wherein the male and female connectors (1, 4) have a radially recessed region.

9. A method of manufacturing a flexible cable rod, comprising the steps of:
inserting one end of a cable rod (7) into a threaded bore of a male connector (1);
inserting the other end of the cable rod into a threaded bore of a female connector (4); and,
swaging or crimping the male and female connectors (1, 4) over the respective ends of the cable rod, such that the threads of the bores of the respective connectors act as teeth to grip the outer edges of the cable rod at the respective swaged or crimped regions.

10. The method of manufacturing a flexible cable rod recited in claim 9, wherein the connectors (1, 4) are generally cylindrical and the connectors are crimped or swaged about their cylindrical part.
